(19) United States
(12) Patent Application Publication
(10) Pub. No.: US 2007/0043901 A1
(43) Pub. Date: Feb. 22, 2007

(54) OPTICAL DISC RECORDING SYSTEM WITH SHARED NON-VOLATILE MEMORY DESIGN

(75) Inventors: Sung-Yang Wu, Taichung County (TW); Meng-Chang Liu, Taipei County (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: MEDIATEK INC., Hsin-Chu (TW)

(21) Appl. No.: 11/459,668

(22) Filed: Jul. 25, 2006

Related U.S. Application Data
(60) Provisional application No. 60/710,083, filed on Aug. 22, 2005.

(51) Int. Cl. G06F 13/00

(52) U.S. Cl. 711/111

(57) ABSTRACT

An optical disc recording system comprises a front-end volatile memory, a back-end non-volatile memory, and a front-end processor. The front-end volatile memory stores sector data. The back-end non-volatile memory stores front-end codes and back-end codes. The front-end processor downloads the front-end codes from the back-end non-volatile memory to the front-end volatile memory, and accesses the sector data in the front-end volatile memory during optical disc recording.

### CROSS REFERENCE TO RELATED APPILCATIONS

This application claims the full benefit and priority of provisional U.S. patent application Ser. No. 60/710,083, filed Aug. 22, 2005, entitled “FLASHLESS FRONT-END CHIP, FLASHLESS BACK-END CHIP IN AN OPTICAL DISC RECORDING SYSTEM AND METHOD THEREOF”, inventor Wu, and incorporates the entire contents of said applications herein.

### BACKGROUND

The invention relates to an optical disc recording system with a single non-volatile memory shared between front-end and back-end, and in particular, to an optical disc recorder with either a flashless front-end processor or a flashless back-end processor.

Typically, there are two flash memories in an optical disc recording system, a front-end flash ROM and a back-end flash ROM. A front-end processor, for example, a microprocessor (uP) fetches instructions such as firmware codes from the front-end flash ROM for executing optical disc recording. A back-end processor fetches instructions from the back-end flash ROM. There are several methods of fetching instructions. FIG. 1 shows a schematic diagram illustrating fetching of instructions in a direct mode. The front-end processor fetches instructions directly from the front-end flash ROM, and accesses the front-end DRAM during recording.

### SUMMARY

An object of the invention is to provide an optical disc recording system. In some embodiments, the optical disc recording system comprises a front-end volatile memory, a back-end non-volatile memory, and a front-end processor. The front-end volatile memory stores sector data to be recorded on an optical disc. The back-end non-volatile memory stores back-end firmware codes and front-end firmware codes. The front-end processor fetches the front-end firmware codes from the back-end non-volatile memory, and stores the front-end firmware codes in the front-end volatile memory at start-up or power-on of the optical disc recording system. The front-end processor fetches and executes the front-end firmware codes and reads/writes sector data from the front-end volatile memory during runtime of disc recording. In some embodiments, a portion of the front-end firmware codes is downloaded to the front-end volatile memory at start-up of the optical disc recording system, and another portion of the front-end firmware codes is downloaded to the front-end volatile memory during runtime or when an optical disc is inserted in the optical disc recording system.

In some other embodiments, an optical disc recording system comprises a back-end volatile memory, a front-end non-volatile memory, and a back-end processor. The front-end non-volatile memory stores back-end firmware codes. The back-end firmware codes are downloaded from the front-end non-volatile memory to the back-end volatile memory. The back-end firmware codes can be completely downloaded to the back-end volatile memory at start-up, or can be partially downloaded to the back-end volatile memory at start-up, and later, the remaining codes can be downloaded to the back-end volatile memory during runtime or when an optical disc is inserted in the optical disc recording system.

An embodiment of a controlling method for an optical disc recording system comprises downloading a first portion of front-end codes to a front-end volatile memory at start-up or power-on of the optical disc recording system, executing the front-end codes for optical disc recording, and downloading a second portion of the front-end codes to the front-end volatile memory at runtime. In an embodiment, the first portion of the front-end codes comprises startup information, and the second portion of the front-end codes comprises disc information. In some other embodiments, the front-end codes are completely downloaded to the front-end volatile memory at start-up.

### DESCRIPTION OF THE DRAWINGS

The following detailed description, given by way of example and not intended to limit the invention solely to the embodiments described herein, will best be understood in conjunction with the accompanying drawings, in which:

FIG. 1 shows a schematic diagram illustrating fetching of instructions from a flash ROM in a direct mode;

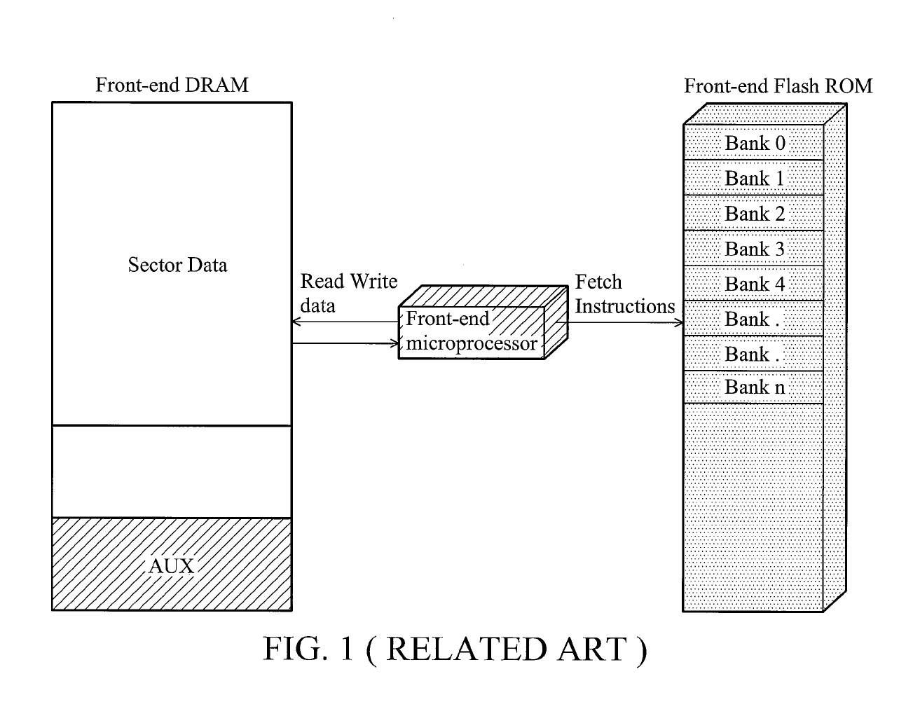

FIG. 2 is a block diagram illustrating an embodiment of an optical disc recording system;

FIG. 3 shows a schematic diagram of exemplary allocations of a front-end DRAM;

FIG. 4 shows a schematic diagram of an exemplary allocation of a front-end flash ROM;

FIG. 5 is a flowchart illustrating a method for downloading the front-end codes at startup;

FIG. 6A is another flowchart illustrating a method for downloading another part of the front-end code at runtime;

FIG. 6B is a flowchart further describing the step in FIG. 6A;

FIG. 7 is a flowchart illustrating one method for downloading parts of the front-end code at startup and runtime respectively;

FIG. 8 is a flowchart illustrating a method for writing information into the back-end flash ROM to update the back-end flash ROM at runtime;

FIG. 9 is a block diagram of another optical disc recording system according to a second embodiment of the invention;

FIG. 10 is a block diagram of an optical disc recording system according to a third embodiment of the invention;

FIG. 11 shows a schematic diagram of several allocations of the back-end DRAM;

FIG. 12 shows a schematic diagram of mapping from a flash ROM to a DRAM.

### DESCRIPTION

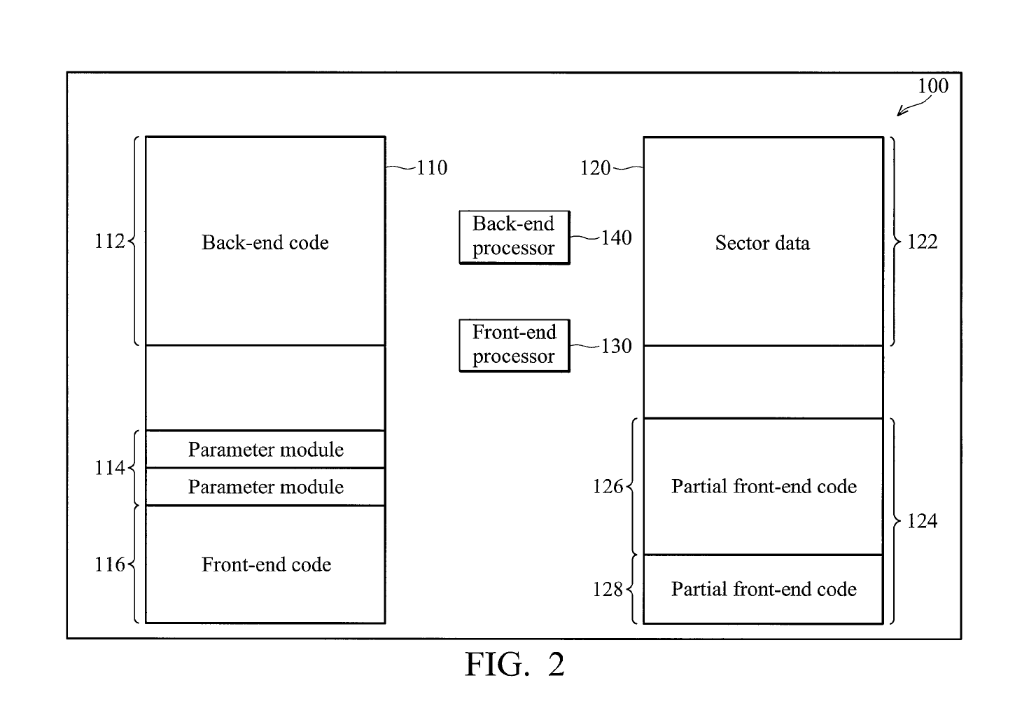

A detailed description of the invention is provided in the following. FIG. 2 is an embodiment illustrating downloading front-end codes from a back-end flash ROM in an optical disc recording system 100. The optical disc recording system 100 comprises a back-end flash ROM 110, a front-end DRAM 120, a front-end processor 130 (e.g. an microprocessor, uP), and a back-end processor 140. The back-end flash ROM 110 stores back-end firmware codes 112, parameter modules 114, and front-end firmware codes 116. The front-end DRAM 120 is used to store sector data 122, and front-end firmware codes 124.

The back-end processor 140 fetches and executes the back-end firmware codes 112. The parameter modules 114 store various front-end parameters, such as parameters for optimum power calibration (OPC), or coordinates/parameters of the power curve. The front-end firmware codes 116 stored in the back-end flash ROM 110 are downloaded into the front-end DRAM 120 for the front-end processor 130. In some embodiments, the front-end firmware codes are downloaded to the front-end DRAM all at once, for example, at start-up of the optical disc recording system. In some other embodiments, as shown in FIG. 2, a portion of the front-end firmware codes 126 is downloaded at start-up or power on, and another portion of the front-end firmware codes 128 is downloaded during runtime or when the recording system determines the type of disc inserted. The front-end processor is no longer requiring a front-end flash ROM since the front-end firmware codes 126 and 128 can be saved in the back-end flash ROM and downloaded at start-up. The front-end processor 130 reads or writes the sector data 122 during recording.

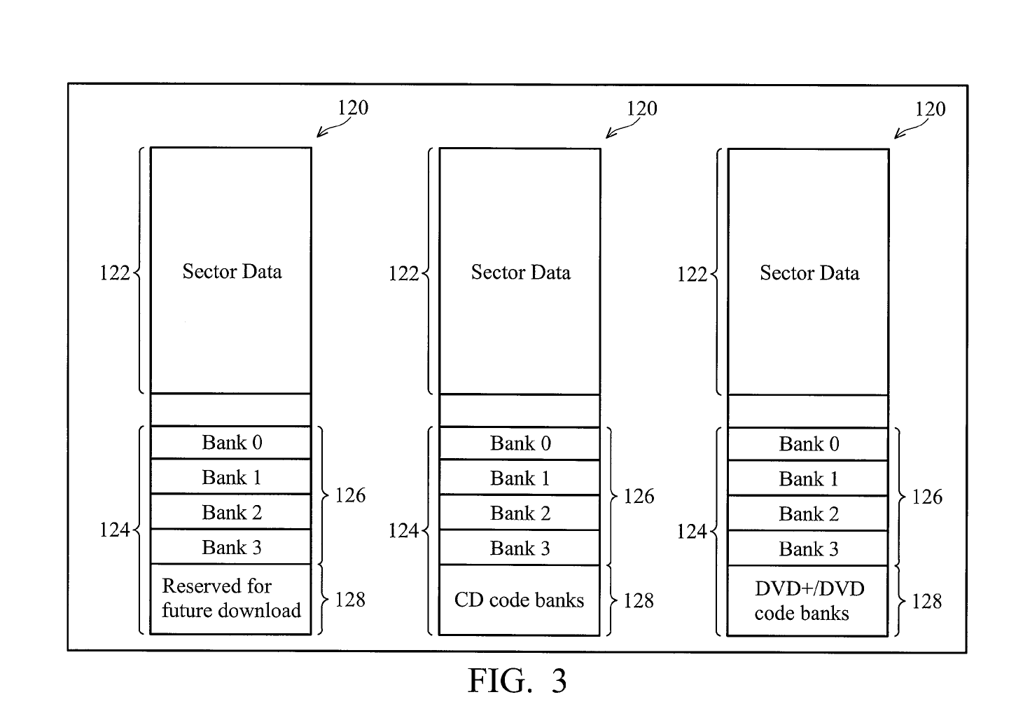

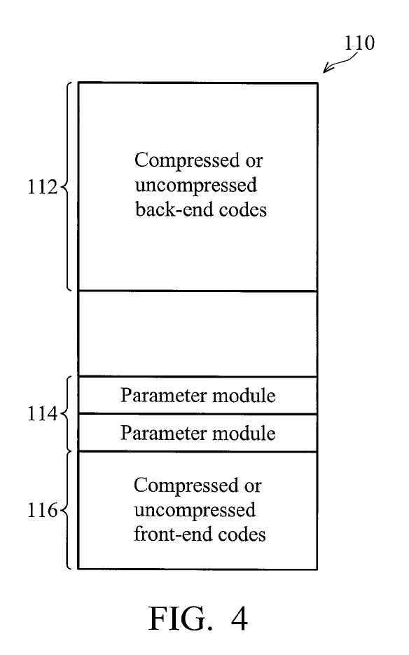

The partial front-end codes 126 are firmware codes that is related to optical disc recording system 100 starts up. The partial front-end codes 128 are firmware codes that the front-end DRAM 120 updates in some special cases (e.g. a user changes discs) when the optical disc recording system 100 is operational at runtime. The content of the partial front-end codes 128 may be dependent on the type or format of the disc inserted in the optical disc recording system 100. FIG. 3 shows a schematic diagram of exemplary allocations of the front-end DRAM 120. In the first allocation, the partial front-end codes 128 may be empty or reserved if there is no disc inserted in the optical disc recording system 100. In the second allocation, firmware codes for CD 128 are downloaded from the back-end flash ROM if a CD disc is loaded in the optical disc recording system 100. In the third allocation, firmware codes for DVD+ or DVD− 128 are downloaded from the back-end flash ROM if a DVD (e.g. DVD+ or DVD−) disc is loaded in the optical disc recording system 100. FIG. 4 shows a schematic diagram of the allocation of the back-end flash ROM 110. Various parameters stored in the parameter modules 114 are updated by the front-end DRAM during recording or at the end of the recording process. Critical and non-critical parameter modules are separately placed in order to prevent simultaneous data crash of all modules. The back-end code 112 is compressed or uncompressed.

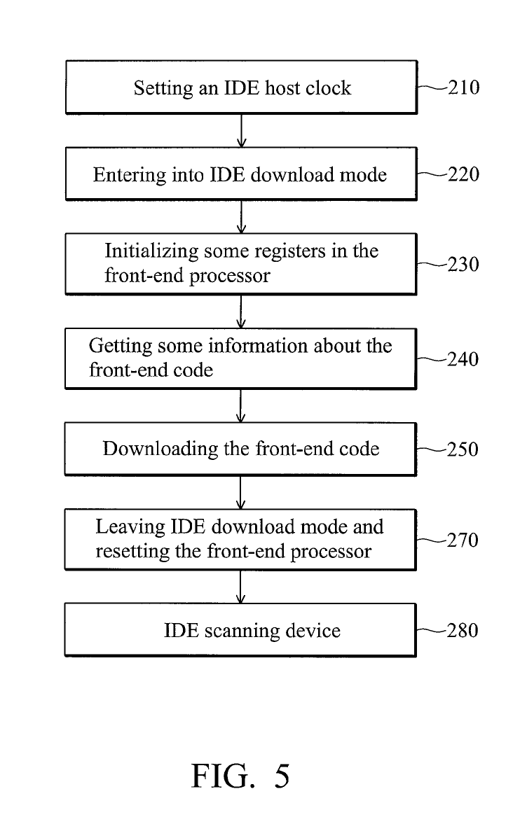

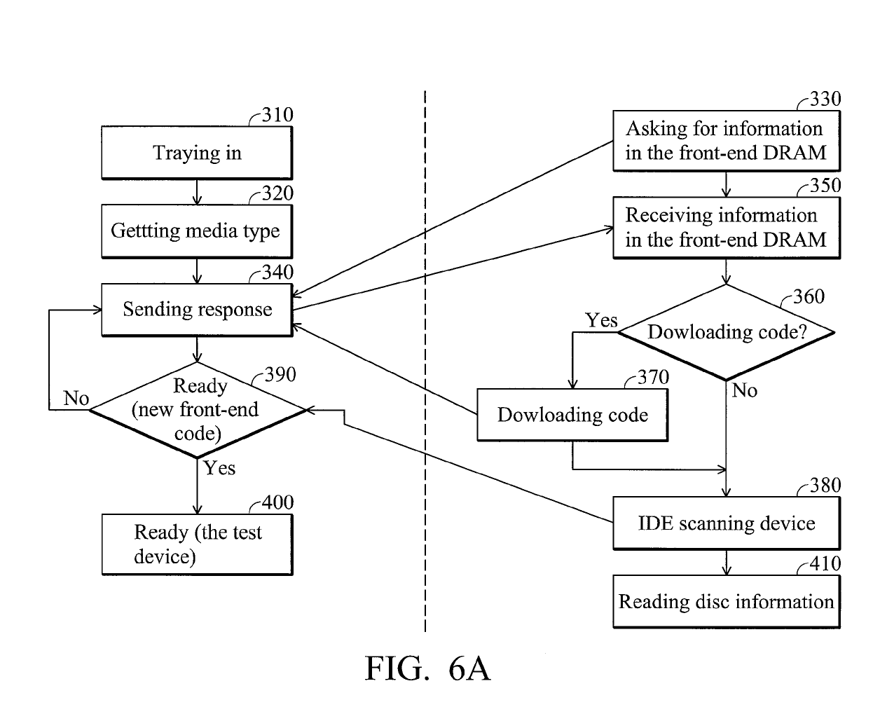

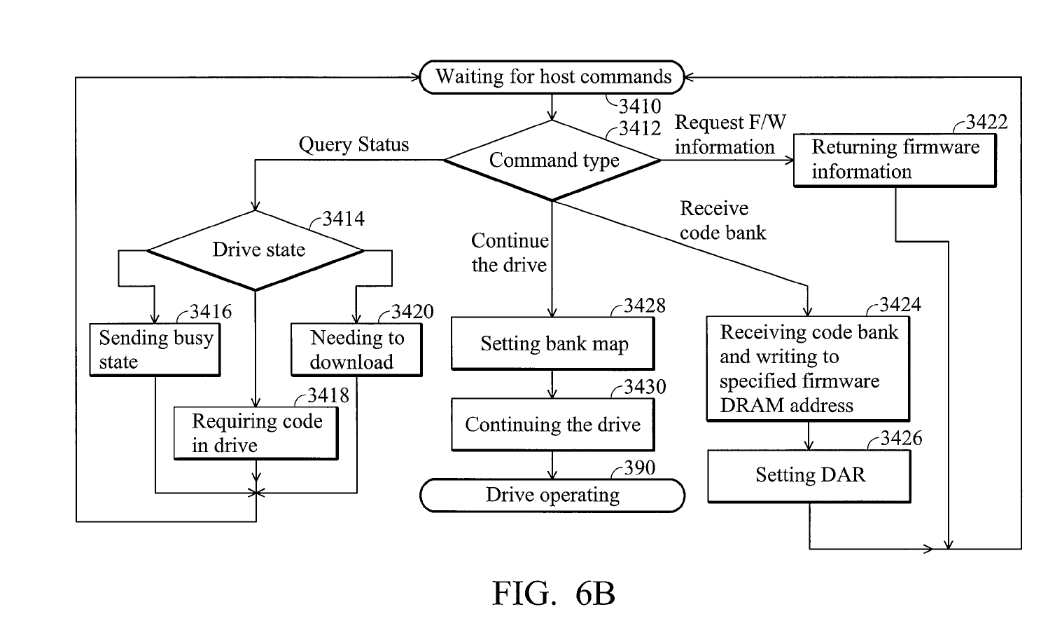

Please refer to FIG. 5 and FIG. 6 in conjunction with FIG. 2. FIG. 5 is a flowchart illustrating one method for downloading the front-end firmware codes 126 at startup. FIG. 6 is another flowchart illustrating one method for downloading the front-end firmware codes 128 at runtime. Please refer to FIG. 5. The optical disc recording system 100 sets an Integrated Drive Electronics (IDE) host clock (step 210) and enters the IDE download mode (step 220). The optical disc recording system 100 then initializes front-end registers (step 230) and the front-end acquires front-end firmware information (step 240). The front-end processor 130 downloads the front-end firmware codes 116 from the back-end flash ROM 110 into the front-end DRAM 120 (step 250). The optical disc recording system 100 then exits the IDE download mode (enters ATAPI mode) and resets the front-end processor (step 270). Finally, an IDE bus is utilized to scan the attached device (step 280).

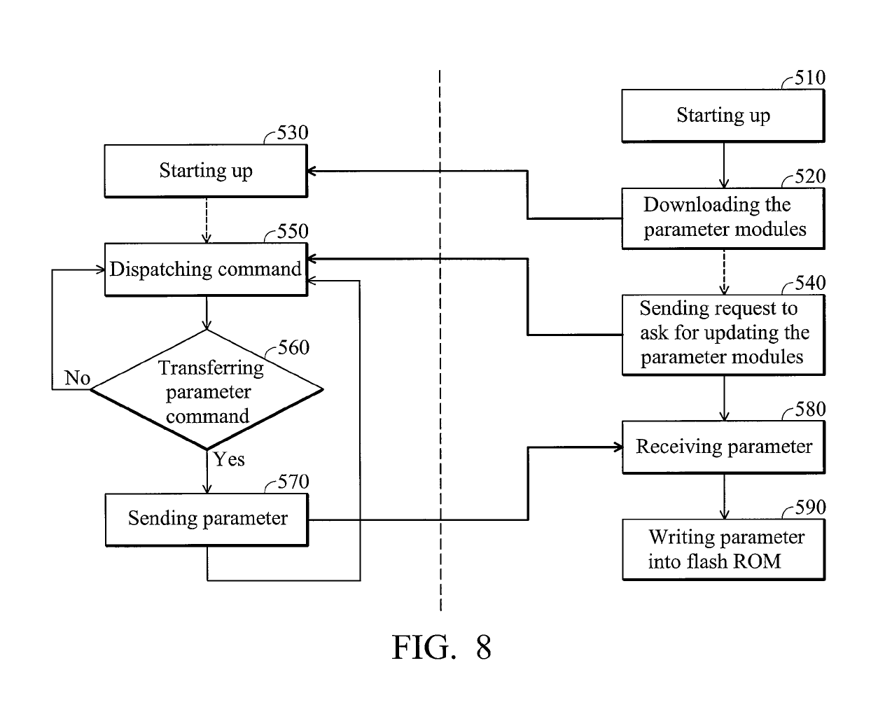

Please refer to FIG. 6A. The front-end processor detects that a new disc is inserted in the optical disc recording system 100 (step 310). A loader (not shown) in the optical disc recording system 100 obtains media type or disc format information of the inserted disc (step 320). The back-end processor sends a request (also called host command) to fetch firmware information from the front-end processor (step 330). The front-end processor sends a response to the back-end processor (step 340 and step 350). The back-end processor determines whether downloading codes during runtime is required by the front-end processor (step 360), and if so, it also determines the codes to be transferred to the front-end DRAM 120. For example, if the firmware information indicates that the disc format of the new disc differs from the previous disc, the back-end processor 140 downloads firmware codes relevant to the new disc from the back-end flash ROM 110, and stores in the front-end DRAM 120 as the partial front-end codes 124 (step 360 and step 370). After confirming downloading of the new front-end codes is ready (step 380 and step 390), the front-end processor 130 begins to read information of the new disc and informs the back-end processor 140 (step 400 and step 410). Additionally, parameters such as write strategy parameters may be stored in the parameter modules 114 of the back-end flash ROM 110, such write-back algorithm is described in detail along with FIG. 8.

FIG. 6B is a flowchart further describing the communication between front-end and back-end as shown in FIG. 6A. The front-end processor awaits host commands sent from the back-end processor (step 3410). If the host command type is query status, the optical disc recording system 100 reads its state (step 3414). If the optical disc recording system 100 is busy reading the new trayed-in disc, it replies busy state (step 3146). If the optical disc recording system 100 finds the new trayed-in disc type is the same as the old one (step 3148), it simply executes the codes already buffered in the front-end DRAM 120 and does not initiate any download. Otherwise, the optical disc recording system 100 requires codes to be downloaded to the front-end DRAM 120 from the back-end flash ROM 110 (step 3420). If the type of host command is request firmware information, the front-end processor returns a response to inform the back-end processor of the firmware information (step 3422 and step 350). If the type of host command is to receive codes, the front-end processor receives codes from the back-end flash ROM 110, writes these codes into specified addresses of the front-end DRAM 120, and sets DRAM Address Register (DAR) of these codes (steps 3424 and 3426). If the type of host command is to continue the operation, the front-end processor sets the bank map and proceeds to step 390 and then proceeds to step 400 (steps 3428 and 3430).

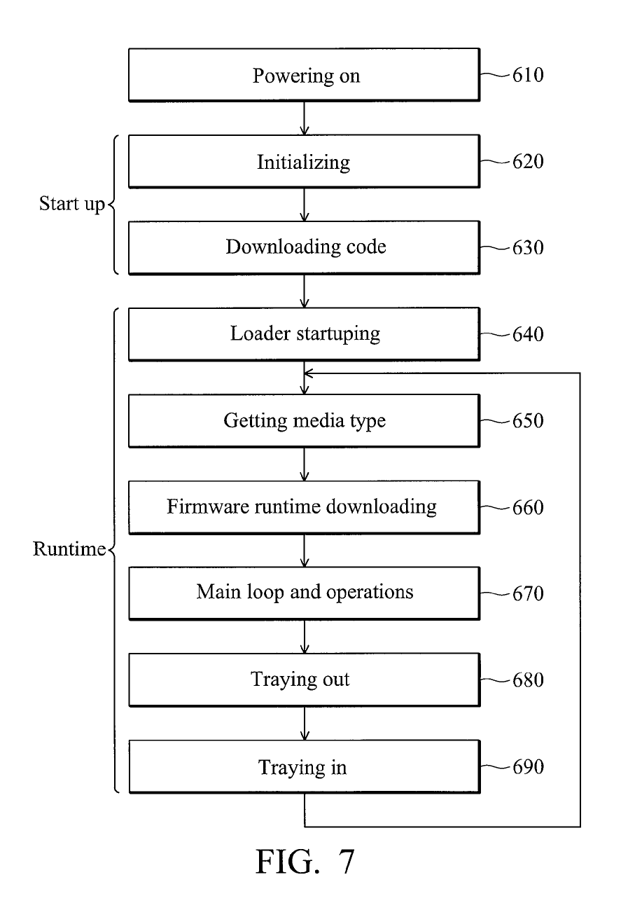

Please refer to FIG. 5 and FIG. 6 in conjunction with FIG. 7. FIG. 7 is a flowchart illustrating an exemplary flow of downloading the front-end codes at startup and runtime. Initially, the optical disc recording system 100 powers on and resets the front-end and back-end processors (step 610). The back-end processor initializes (step 620) and downloads partial front-end codes 126 from the back-end flash ROM 110 into the front-end DRAM 120 at startup (step 630). The front-end processor detects that the disc in the optical disc recording system 100 has been changed, so that the loader obtains media type information of the new trayed-in disc. If necessary, and the front-end processor 130 performs download routine of the partial front-end codes 128 at runtime (steps 640-660). The front-end processor executes recording operations (step 670) until the user changes the disc (steps 680 and 690), when a new disc is inserted in the optical disc recording system 100, the flow repeats the steps 650-670.

FIG. 8 is a flowchart illustrating an embodiment of writing information (e.g. parameters for optical disc recording) into the back-end flash ROM 110 to update the back-end flash ROM 110 at runtime. At start up, the optical disc recording system 100 downloads the parameter modules 114 into the front-end DRAM 120 from the back-end flash ROM 110 (steps 510, 520 and 530). The back-end processor 140 may send a request for update of the parameter modules 114 (step 540). The front-end processor 130 dispatches commands and determines whether new parameters in the front-end DRAM 120 are to be transferred to the back-end flash ROM 110 (step 550 and 560). If it is determined that the new parameters are to be sent, the back-end processor 140 receives and writes the parameters into its back-end flash ROM 110 (steps 570, 580, and 590).

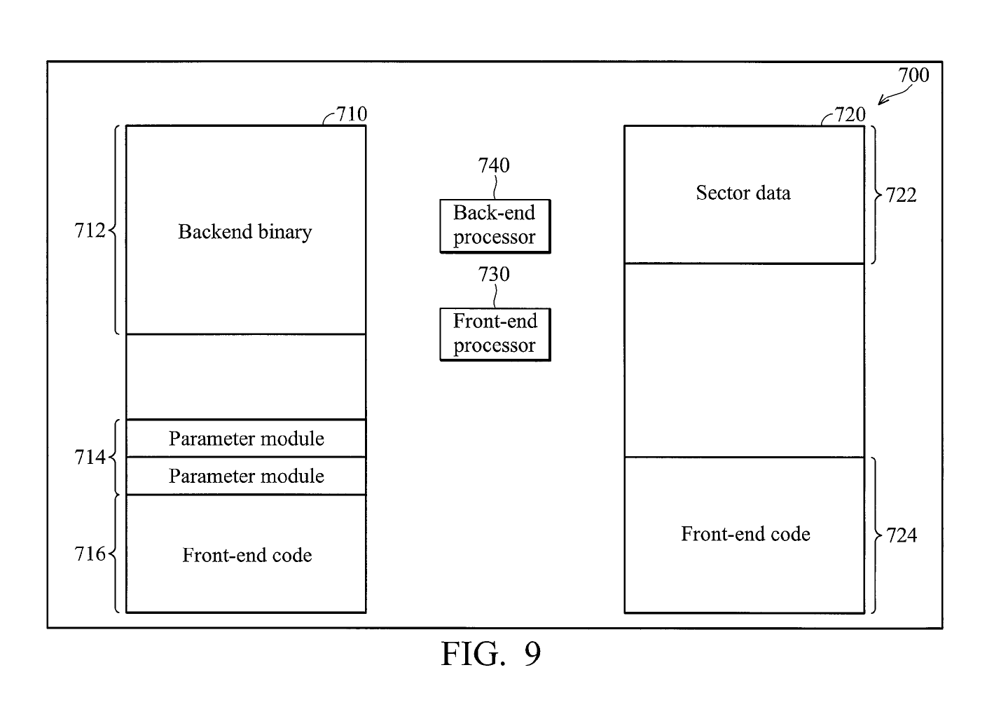

FIG. 9 is a block diagram illustrating downloading front-end codes from a back-end flash ROM in an optical disc recording system 700. The optical disc recording system 700 comprises a back-end flash ROM 710, a front-end DRAM 720, a front-end processor 730 (e.g. uP), and a back-end processor 740. The functionality and operations of the optical disc recording system 700 is similar to that of the optical disc recording system 100 shown in FIG. 2. The difference is that front-end codes 716 are downloaded into the front-end DRAM 720 as front-end codes 724 once. In other words, the front-end processor 730 does not download firmware codes from the back-end flash ROM 710 when the optical disc recording system 700 is operating at runtime. A front-end non-volatile memory is therefore no longer required in the optical disc recording systems 100 and 700 since the codes may be stored in the back-end non-volatile memory and downloaded by the front-end processor if necessary.

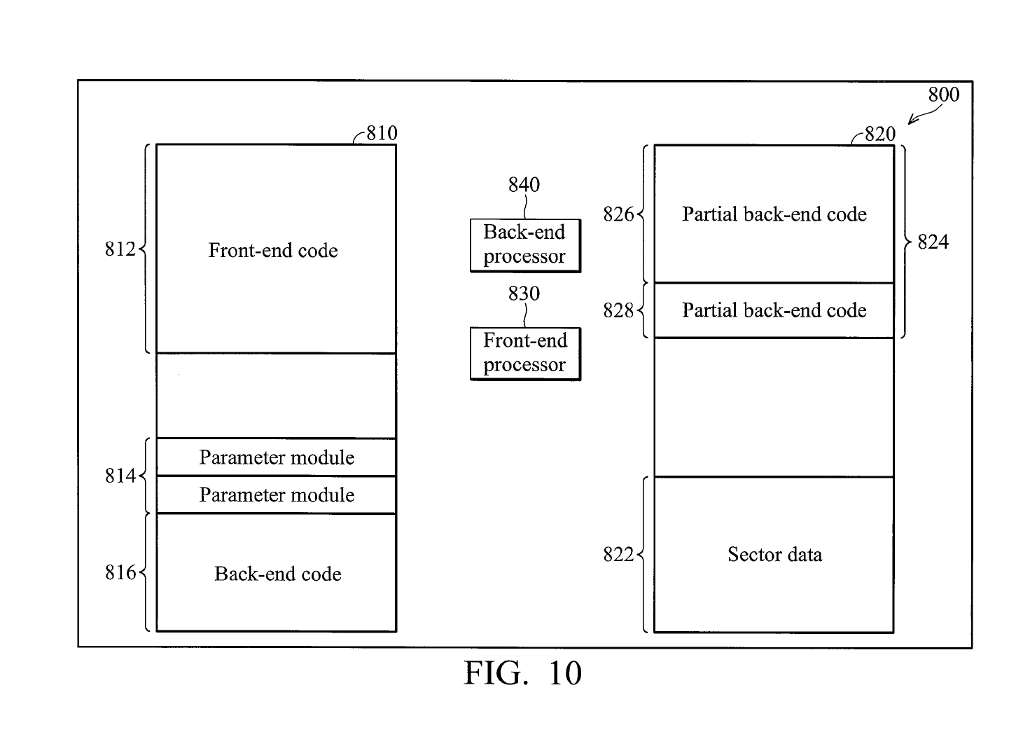

FIG. 10 is a block diagram illustrating downloading back-end codes from a front-end flash ROM in an optical disc recording system 800. The optical disc recording system 800 comprises a front-end flash ROM 810, a back-end DRAM 820, a front-end processor 830 (e.g. uP), and a back-end processor 840. The front-end flash ROM 810 stores front-end codes 812, parameter modules 814, and back-end codes 816. The back-end DRAM 820 for buffering sector data 822 may request back-end codes 826 and 828 from the front-end flash ROM 810.

Similar to the previous descriptions of downloading front-end codes from a back-end non-volatile memory, the optical disc recording system may operate in either total download mode or partial download mode. When operating in the total download mode, the back-end processor 840 downloads the back-end codes 816 into the back-end DRAM 820 as codes 824 at once. When operating in the partial download mode, a portion of the back-end codes 816 is downloaded into the back-end DRAM 820 as back-end codes 826 at start-up (or boot up) of the system 800, and another portion of the back-end codes 816 is downloaded into the back-end DRAM 820 as back-end codes 828 during runtime. The back-end processor (host)of the optical disc recording system 800 maybe flashless, meaning a back-end non-volatile memory is not required.

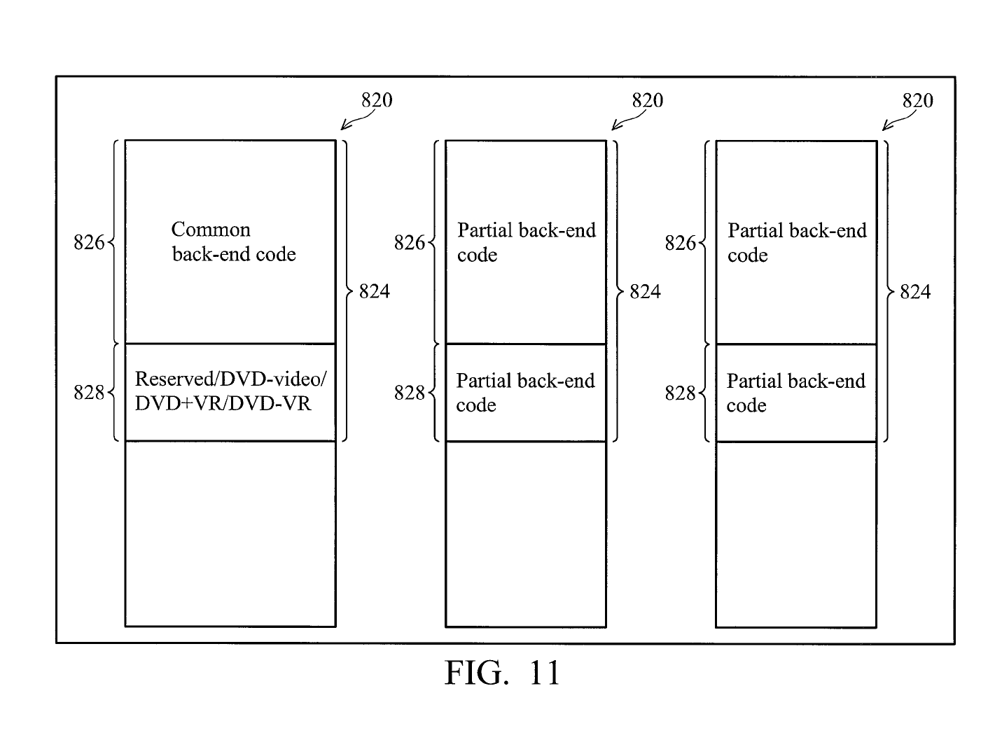

The partial back-end codes 828 are firmware codes that the back-end processor 840 may fetch in special cases (e.g. the user changes discs) when the optical disc recording system 800 is operating at runtime. In some embodiments, the content of the partial back-end codes 828 is dependent on the recording format of the disc inserted in the optical disc recording system 800. FIG. 11 shows a schematic diagram illustrating several allocations of the back-end DRAM 820. In the first allocation, the space for partial back-end code 828 in the back-end DRAM 820 is empty or reserved at start-up. In the second allocation, the recording format is determined as DVD-Video, thus the partial back-end codes 828 downloaded from the front-end non-volatile memory corresponds to DVD-Video. In the third allocation, the disc in the system is to be recorded in DVD+VR (or DVD-VR) format, the back-end processor 840 downloads partial back-end codes 828 corresponds to DVD+VR (or DVD-VR). A detailed description of the startup download and runtime download process is similar to previous discussed embodiments, and is omitted here for the sake of brevity.

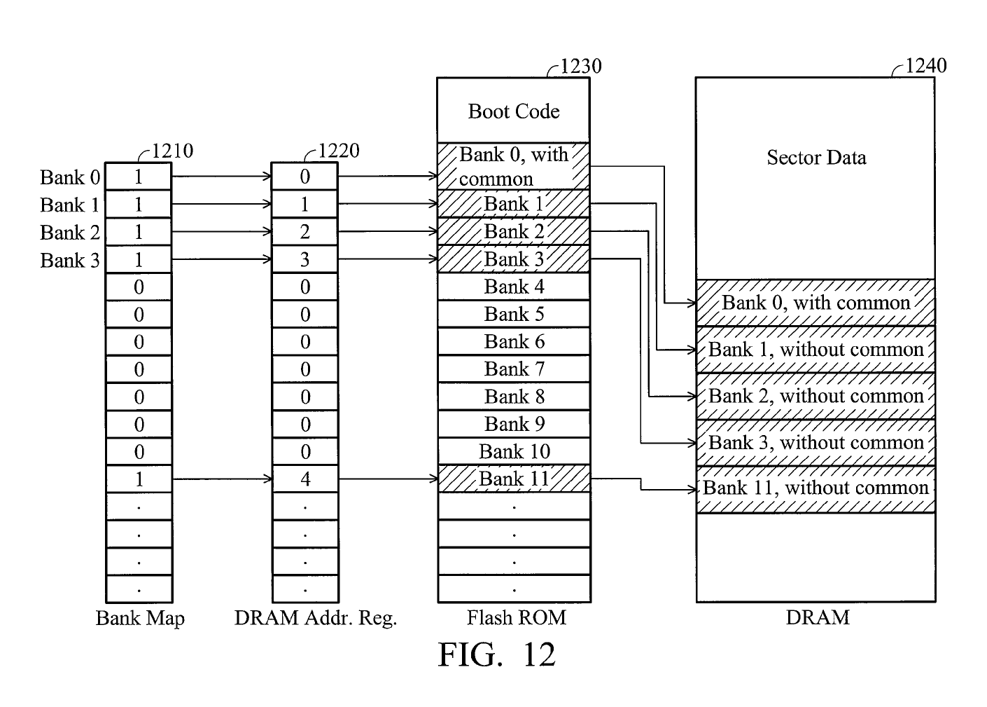

FIG. 12 shows a schematic diagram illustrating bank mapping from a flash ROM 1230 to a DRAM 1240. For example, the flash ROM 1230 controlled by the back-end processor stores front-end firmware codes to be downloaded into the front-end DRAM 1240. The back map 1210 marks each bank that is to be downloaded from the flash ROM 1230 to the DRAM 1240, in other words, the marked banks stores front-end firmware codes requested by the front-end. The DRAM Address Register (DAR) 1220 records the DRAM address or DRAM bank number for each bank being downloaded from the flash ROM 1230. In the example shown in FIG. 12, common codes in Bank 0 of the flash ROM 1230 are downloaded to Bank 0 of the DRAM 1240 at start-up, and when a disc is inserted, codes in Banks 1, 2, 3, and 11 of the flash ROM 1230 are downloaded to Bank 1, 2, 3, and 4 of the DRAM 1240 respectively during runtime.

The codes stored in the memory (e.g. back-end flash ROM, back-end DRAM, front-end flash ROM, or front-end DRAM) may be compressed or uncompressed, and the codes in each back can be independently compressed or uncompressed with respect to the other banks.

Compared with the related art, some embodiments of the optical disc recording system of the invention utilizes a back-end flash ROM to store front-end codes, and hence does not require use of an extra front-end flash ROM. The optical disc recording system may also utilize partial download mode to reduce the amount of data to be downloaded into the front-end DRAM at start-up, therefore reducing the memory capacity in the front-end DRAM reserved for the front-end firmware codes. Similarly, some embodiments of optical disc recording system utilizes a front-end flash ROM to store back-end codes, and hence does not require use of an extra back-end flash ROM. The partial download mode may also reduce memory capacity in a back-end DRAM reserved for the back-end firmware codes. Various embodiments of the optical disc recording system of the invention not only decreases hardware cost by eliminating the extra non-volatile memory, but also utilize DRAM space efficiently.

While the invention has been described by way of example and in terms of the preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An optical disc recording system comprising:
a front-end volatile memory for storing sector data;
a back-end non-volatile memory storing front-end codes and back-end codes; and
a front-end processor downloading the front-end codes from the back-end non-volatile memory to the front-end volatile memory, and accessing the sector data in the front-end volatile memory during optical disc recording.

2. The optical disc recording system according to claim 1, wherein the front-end codes are downloaded into the front-end volatile memory at start-up of the optical disc recording system.

3. The optical disc recording system according to claim 1, wherein a first portion of the front-end codes is downloaded into the front-end volatile memory at start-up of the optical disc recording system, and a second portion of the front-end codes is downloaded into the front-end volatile memory during runtime of optical disc recording.

4. The optical disc recording system according to claim 1, wherein the front-end volatile memory is a front-end DRAM, and the back-end non-volatile memory is a back-end flash ROM.

5. The optical disc recording system according to claim 3, wherein the second portion of the front-end codes comprises disc format dependent information, and the front-end processor downloads the second portion of the front-end codes according to the disc format of the disc inserted in the optical disc recording system.

6. The optical disc recording system according to claim 1, wherein the front-end processor sends new parameters to update the data in the back-end non-volatile memory.

7. The optical disc recording system according to claim 6, wherein the parameters comprise parameters for optimum power calibration (OPC).

8. An optical disc recording system comprising:
a back-end volatile memory for storing sector data;
a front-end non-volatile memory storing front-end codes and back-end codes; and
a back-end processor downloading the back-end codes from the front-end non-volatile memory into the back-end volatile memory, and accessing sector data in the back-end volatile memory;

9. The optical disc recording system according to claim 8, wherein the back-end codes are downloaded into the back-end volatile memory at start-up of the optical disc recording system.

10. The optical disc recording system according to claim 8, wherein a first portion of the back-end codes is downloaded into the back-end volatile memory at start-up of the optical disc recording system, and a second portion of the back-end codes is downloaded into the back-end volatile memory during runtime of optical disc recording.

11. The optical disc recording system according to claim 8, wherein the back-end volatile memory is a back-end DRAM and the front-end non-volatile memory is a front-end flash ROM.

12. The optical disc recording system according to claim 10, wherein the second portion of the back-end codes comprises recording format dependent information, the back-end processor downloads the second portion of the back-end codes according to the recording format for the disc inserted in the optical disc recording system.

13. A controlling method for an optical disc recording system comprising a front-end volatile memory, a back-end non-volatile memory, and a front-end processor, comprising:
initializing the optical disc recording system;
downloading a first portion of front-end codes from the back-end non-volatile memory to the front-end volatile memory at startup; and
downloading a second portion of the front-end codes to the front-end volatile memory at runtime.

14. The controlling method according to claim 13, wherein the first portion of the front-end codes comprises startup information, and the second portion of the front-end codes comprises disc format information.

15. The controlling method according to claim 13, wherein the step of downloading the first portion of the front-end codes at start-up further comprises:
setting an INTEGRATED DRIVE ELECTRONICS (IDE) host clock;
entering into an IDE download mode;
initializing registers;
getting information about the first portion of the front-end codes;
downloading the first portion of the front-end codes; and
leaving IDE download mode.

16. The controlling method according to claim 13, wherein the step of downloading the second portion of the front-end codes at runtime further comprises:
getting disc format information; and
downloading the second portion of the front-end codes from the back-end non-volatile memory according to the disc format information.

17. The controlling method according to claim 13 further comprising writing information into the back-end non-volatile memory to update the back-end non-volatile memory at runtime.

18. The controlling method according to claim 17, wherein the step of writing information further comprises:
requesting for updating parameters in the back-end non-volatile memory; and
receiving the parameters from the front-end volatile memory and storing the parameters in the back-end non-volatile memory.
